(19) United States
(12) Patent Application Publication
(10) Pub. No.: US 2019/0286349 A1
(43) Pub. Date: Sep. 19, 2019

(54) CONTROLLER AND DATA STORAGE METHOD

(71) Applicant: OMRON Corporation, KYOTO (JP)

(72) Inventors: Yuta NAGATA, Kyoto-shi (JP); Shinichiro KAWAGUCHI, Kyoto-shi (JP)

(73) Assignee: OMRON Corporation, KYOTO (JP)

(21) Appl. No.: 16/248,773

(22) Filed: Jan. 16, 2019

(30) Foreign Application Priority Data
Mar. 14, 2018 (JP) 2018-046420

(51) Int. Cl. G06F 3/06; G05B 19/042

(52) U.S. Cl. CPC G06F 3/0625; G06F 3/0688; G06F 3/0655; G05B 19/0425

(57) ABSTRACT

In the disclosure, HMI data is mirrored under high robustness. An IPC operates in an OS and a real time OS. The IPC includes a first data managing part that sequentially performs acquisition processing of the HMI data by an HMI application of the OS, a buffer memorizing the HMI data by the first data managing part, a second data managing part that exchanges data with the first data managing part by a mirroring processing part of the real time OS, and a mirroring data holding part memorizing data by the second data managing part. The data managing part memorizes the HMI data in the buffer for each acquisition of the HMI data and transmits the HMI data to the second data managing part as mirroring data, the data managing part memorizes the mirroring data in the mirroring data holding part for each reception of the minoring data.

### CROSS-REFERENCE TO RELATED APPLICATION

This application claims the priority benefit of Japan Application No. 2018-046420, filed on Mar. 14, 2018. The entirety of the above-mentioned patent application is hereby incorporated by reference herein and made a part of this specification.

### BACKGROUND

### Technical Field

The disclosure relates to a controller and a data storage method for mirroring data of process management, etc.

### Description of Related Art

In a process control system, from the perspective of robustness, it is known to separately capture process management data relating to the state of the control object as mirroring (memorizing the same contents at two locations at the same time) data. For example, Patent Document 1 (Japanese Laid-Open No. 2016-27565) describes a process control system where, in a mode in which a plurality of I/O (Input/Output) modules 204 that acquire data from various sensors on the side of the control object are used, a plurality of control modules 206 for monitoring and controlling these I/O modules 204 are provided for redundancy, and such control modules 206 perform mirroring of an information database relating to the I/O modules 204.

In the process control system, the mirroring processing in which human machine interface (HMI) data inputted at a high frequency by a user program (control program) is captured to a buffer and captured to a magnetoresistive random access memory (MRAM) for minoring processing is also known. With the possibility of infinite rewriting as well as high speed and non-volatility, the MRAM exhibits strong robustness against abnormalities such as power failure.

### RELATED ART DOCUMENT(S)

### Patent Document(s)

[Patent Document 1] Japanese Laid-Open No. 2016-27565

Recently, an industrial personal computer (IPC) system including a programmable logic controller (PLC) system and a programmable display device as the HMI, and controlling the operation of a control object such as a machine or an apparatus is known. Since the IPC operates on a general-purpose operating system (OS) such as Windows (registered trademark) and generally does not have an MRAM, a technique which replaces MRAM is required for minoring processing of the HMI data.

For example, although an alternative technology in which the HMI data is flushed (written) to a disk (HDD/SSD) for each input can be considered, writing at a high frequency leads to the issue of disk life, and data may be damaged if power interruption (power cutoff) occurs during writing.

Further, although an alternative technique in which the mirroring processing of the HMI data is performed by using a memory mapped file mapped to the virtual memory space can be considered, depending on the timing of flushing to the disk, the issue of data loss may arise. In order to prevent data loss, since the HMI data is flushed at a high frequency, the issue of disk life as described above also arises.

### SUMMARY

An aspect of the disclosure provides a controller which includes a control part operating on a first operating system and a second operating system for controlling a control object. The controller includes: a first data managing part that performs acquisition processing of periodically input first data by an application program operating on the first operating system; a first memory in which the first data is memorized by the first data managing part; a second data managing part that exchanges data with the first data managing part by an application program operating on the second operating system; and a second memory in which data is memorized by the second data managing part. The first data managing part transmits the acquired first data to the second data managing part as mirroring data. The second data managing part memorizes the mirroring data in the second memory.

In addition, another aspect of the disclosure provides a process management data storage method in which a control part operating on a first operating system and a second operating system for controlling a control object performs following: an acquisition step of acquiring periodically input first data by an application program operating on the first operating system; a first memory step of memorizing the first data acquired in the acquisition step in a first memory; a transmission step of transmitting the first data acquired in the acquisition step to the side of the second operating system as mirroring data; and a second memory step of memorizing the mirroring data in a second memory by an application program operating on the second operating system.

### BRIEF DESCRIPTION OF THE DRAWINGS

FIG. 1 is a block diagram showing an outline of an IPC system showing an example to which a controller according to the disclosure is applied.

FIG. 2 is a block diagram showing an embodiment of a controller according to the disclosure.

FIG. 3 is a detailed functional configuration diagram of the controller of FIG. 2.

FIG. 4 is a flowchart showing startup processing executed by an OS.

FIG. 5 is a flowchart showing processing from operation to end executed by an OS.

FIG. 6 is a flowchart showing power interruption processing, etc., executed by a real-time OS.

FIG. 7 is another block diagram of a controller.

### DESCRIPTION OF THE EMBODIMENTS

The disclosure provides a controller and a data storage method that ensure high robustness by performing mirroring processing with a dedicated operating system.

According to the embodiments of the disclosure, typically, the first data such as the HMI data that is continuously acquired by the first data managing part (application program) operating on the general-purpose first operating system is stored in the first memory as appropriate, and the acquired first data is transmitted as the mirroring data to the side of the second operating system operating with a common processor. The mirroring processing is performed by storing the mirroring data in the second memory by the second data managing part (application program) operating on the second operating system. With the storing processing of the first data performed at the side of the second operating system, data corruption of the first data can be prevented, data loss can be minimized, and data can be restored. Also, even in the case where an abnormality such as freezing of one of the operating system sides (including a blue screen), abnormal termination, power interruption, etc., occurs, the first data can be restored and high robustness is exhibited.

An embodiment of the disclosure also includes a first nonvolatile memory in which contents of the first memory are stored by the first data managing part at a time when the application program of the first operating system ends. According to this configuration, with the latest (final) first data being stored, that is, at the time point when the application program at the first operating system side ends, the latest data can be restored.

An embodiment of the disclosure includes a power interruption detecting part that detects power interruption of the control part, and a second nonvolatile memory in which contents of the second memory are stored by the second data managing part upon detection of the power interruption. According to this configuration, by allowing the first data at the time of abnormal termination such as power interruption to be saved and stored, data can be restored at the next startup.

Also, an embodiment of the disclosure includes a power interruption detecting part that detects power interruption of the control part and a second nonvolatile memory in which contents of the second memory are stored by the second data managing part upon detection of the power interruption. The second data managing part transmits contents of the second nonvolatile memory to the first data managing part in response to a request from the first data managing part. The first data managing part, at a time of startup of the control part, reads the contents of the first nonvolatile memory, compares the contents of the first nonvolatile memory with the contents of the second nonvolatile memory that are received, and restores latest contents to the first memory. According to this configuration, when the application program at the first operating system side is started, the latest data of the first data stored at the first operating system side and the mirroring data stored at the second operating system side is used for restoration.

An embodiment of the disclosure also includes a backup memory in which data is memorized by the second data managing part. The second data managing part, at a time of startup of the second operating system, reads the contents of the second nonvolatile memory to the backup memory, and transmits contents of the backup memory to the first data managing part in response to a request from the first data managing part. According to this configuration, by reading the contents of the second nonvolatile memory to the backup memory by the second operating system started after power interruption, at the time of restoration of the first memory, the contents of the backup memory are transmitted to the first data managing part in response to the request and provided for data restoration.

In addition, according to an embodiment of the disclosure, the second operating system is a real-time operating system. According to this configuration, it is suitable for executing a series of processing in process control in a predetermined processing time with high responsiveness.

According to the disclosure, the first data can be mirrored under high robustness.

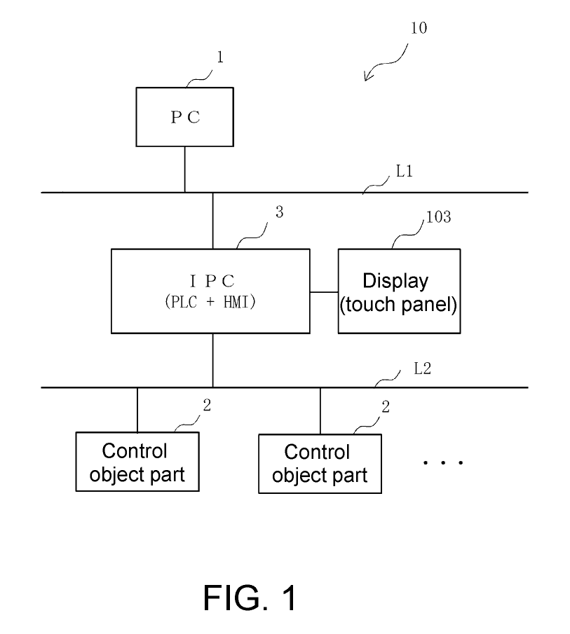

FIG. 1 is a block diagram showing an outline of an IPC system showing an example to which a controller according to the disclosure is applied. In FIG. 1, an IPC system 10 includes a personal computer (PC) 1, an industrial personal computer (IPC) 3 as a controller, and various or a required number of control object parts 2 whose operations are controlled by a control signal generated by a control program of the IPC 3. The control object part 2 is typically a machine, an apparatus, etc. The PC 1 is a personal computer for memorizing an application program serving to cause the control object parts 2 to perform desired operations and created by a system administrator, and a setting data file including various operation setting values (holding variables and the like) to the side of the IPC 3.

The PC 1 and the IPC 3 are connected by an Ethernet (registered trademark) L1, and can exchange information. In addition, the IPC 3 and the various control object parts 2 are connected by an EtherCAT (registered trademark) L2, and can exchange data. The EtherCAT (registered trademark) L2 is an open network for industrial use and is used as a field network.

The IPC 3 is connected to a display 103 composed of a touch panel. The IPC 3 has a configuration including a programmable logic controller (PLC) and an HMI part. The IPC 3 inputs operation data from the side of the display 103, inputs each data from the control object parts 2 or a sensor not shown herein, and generates and outputs a control signal (PLC data) for causing the operation of each of the control object parts 2 from these input data. In the following description, among the operation data from the side of the display 103, the various data from the control object parts 2 and the sensor (not shown), etc., and others (for example, the holding variable used when creating the control signal, the alarm data showing abnormalities and contents thereof, and the logs of various data) are included and referred to as HMI data (corresponding to first data in the disclosure).

The CPU (Central Processing Unit) (processor) in the IPC 3 operates on a general-purpose operating system (OS) such as Windows (registered trademark), which performs processing relating to acquisition and management of the HMI data, and operates on a built-in real-time OS, such as QNX, suitable for executing a series of processes on the control object parts 2 in a predetermined processing time with high responsiveness in this embodiment.

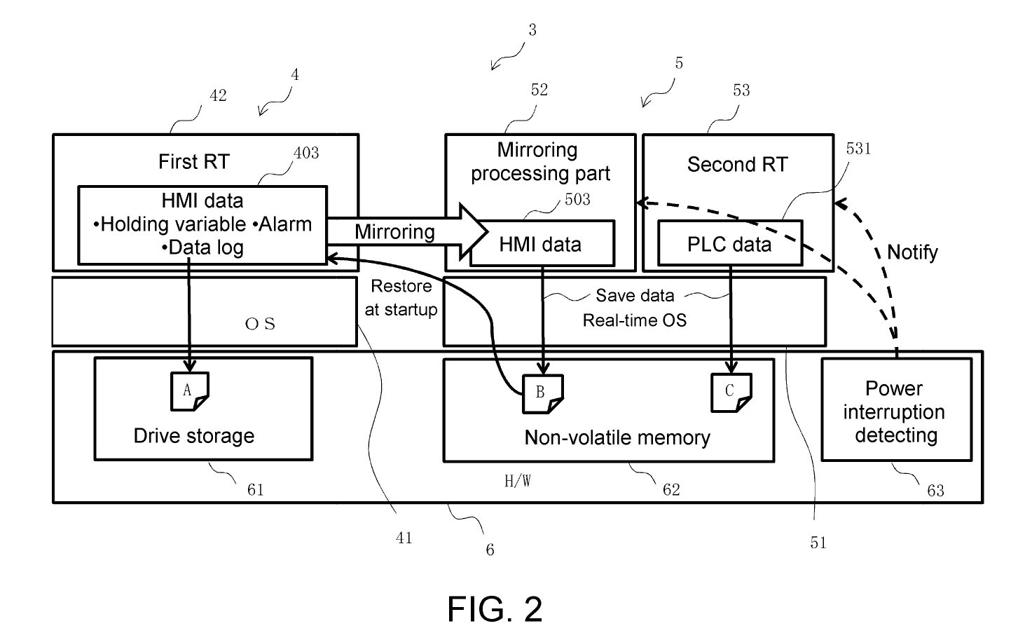

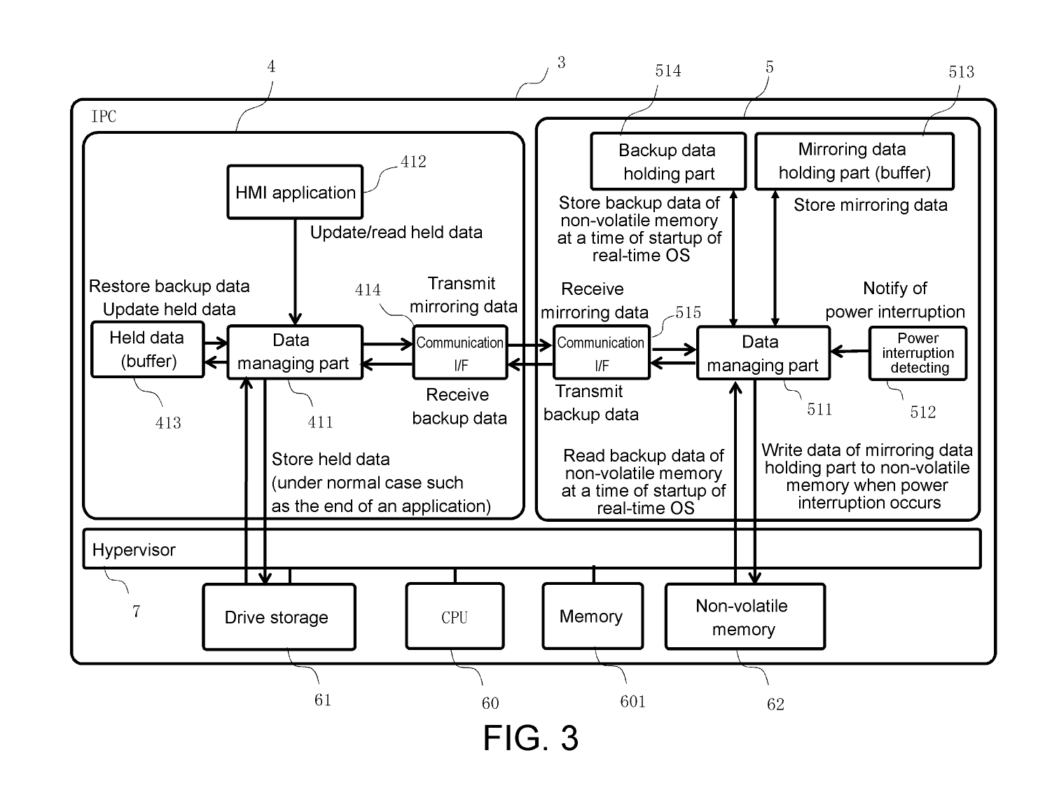

FIG. 2 is a block diagram showing an embodiment of a controller according to the disclosure. FIG. 3 is a detailed functional configuration diagram of the controller of FIG. 2. In FIGS. 2 and 3, the IPC 3 includes a software part and a hardware (H/W) part 6. The software part consists of an OS part 4 which includes a first runtime (RT) 42 as an application program operating on an OS 41 and a real-time OS part 5 which includes a mirroring processing part 52, such as a simple redundant array of inexpensive disk (RAID), etc., that executes mirroring processing to a volatile memory and is as an application program operating on a real time OS 51 and a second runtime (RT) 53 that processes PLC data 531 (second data). The hardware 6 has a CPU (processor) 60, a memory 601, a drive storage 61, and a non-volatile memory 62. The drive storage 61 refers to an HDD or SSD. Also, in replace of the nonvolatile memory 62, a realizing means with another nonvolatile memory, such as a battery-attached SRAM (static random-access memory), may also be adopted.

The OS 41 and the real-time OS 51 are executed in a virtual environment by using a hypervisor 7, etc. The real-time OS 51 is a highly reliable OS, and is capable of stably controlling the control object parts 2. Compared with the real-time OS 51, the OS 41 is less reliable, but has high versatility and can execute various general-purpose applications or user applications. Through operating at a lower level than the OS 41 and the real-time OS 51, the hypervisor 7 can control multiple OSs (the OS 41 and the real-time OS 51 in this example) by reproducing (emulating) the hardware configuration, and thereby construct multiple virtual environments on one processor.

In FIG. 2, in the mirroring processing, the first RT 42 on the OS 41 stores HMI data 403, namely the holding variable, alarm data and data logs, sequentially input along the time axis in a buffer, etc., and transmits the HMI data 403 to the side of the real time OS 51 as mirroring data. The mirroring processing part 52 stores HMI data 503 in a buffer, etc., on the real time OS 51.

The HMI data 403 is stored as a file A in the drive storage 61 of the hardware 6 at a necessary timing, such as the end of the first RT 42. Since the storing operation can be reduced with the storing processing being carried out at such an appropriate timing, the life of the disk can be extended. In addition, the HMI data 503 stored as mirroring data by the mirroring processing part 52 is stored (saved) as a file B in the non-volatile memory 62 when an abnormality occurs, for example, when the stop of power supply is detected (when power interruption is detected) in the embodiment. By storing at the timing such as occurrence of an abnormality, the load of the real-time OS 51 is reduced. Like the HMI data (first data), the PLC data (second data) created by the second RT 53 operating on the real-time OS 51 is also stored (saved) as a file C in the nonvolatile memory 62 when power interruption occurs.

Also, when the OS 41 is started, the HMI data as the file A and the HMI data as the file B are compared on time stamps indicating the storing time points, for example, and the latest HMI data is provided for restoration. As is known, the time stamps can be made available by associating time information from an internal timer (not shown) at the time point of the processing for object information.

Then, with reference to FIG. 3, the functional configurations at the side of the OS part 4 and the side of the real time OS part 5 and the flow of the HMI data will be described. The OS part 4 functions as a data managing part 411 by executing the OS 41 and the first RT 42 (such as an HMI application 412) operating on the OS 41. The OS part 4 further includes a held data buffer 413 and a communication I/F (interface) 414.

During operation, the data managing part 411 updates and stores the HMI data sequentially input from the side of the display 103 and the control object parts 2 to the held data buffer 413, and outputs the HMI data as mirroring data to the communication I/F 414. Further, the data managing part 411 stores the contents of the held data buffer 413 in the drive storage 61 at the time when the HMI application 412 ends. In addition, at the time of startup, by reading the HMI data lastly stored in the drive storage 61, reading the HMI data lastly stored in the nonvolatile memory 62 at the side of the real time OS part 5, and comparing the time stamps of the two HMI data, the data managing part 411 selects and restores the latest HMI data to the held data buffer 413.

The real-time OS part 5 functions as a data managing part 511 and a power interruption detecting part 512 by executing the real time OS 51 and the mirroring processing part 52 operating on the real time OS 51. The power interruption detecting part 512 may take various forms, and may be, for example, a general sensor configuration that detects the voltage level of a power line and compares the voltage level with a threshold value. The real-time OS part 5 further includes a mirroring data holding part 513 as a buffer, a backup data holding part 514 as a buffer, and a communication I/F 515. The communication method between the communication I/F 414 and the communication I/F 515 is not particularly specified, and may be, for example, Ethernet (registered trademark) or virtual bus (VMBus).

During operation, the data managing part 511 stores the HMI data, which is the mirroring data transmitted from the communication I/F 414 to the communication I/F 515, to the mirroring data holding part 513. Further, when power interruption is detected, the data managing part 511 writes the HMI data stored in the mirroring data holding part 513 to the nonvolatile memory 62. Various modes can be adopted as the countermeasure against power interruption. For example, a built-in rechargeable battery or a known protection circuit may be installed, so that the CPU 60 secures the processing time until the interruption. Further, the data managing part 511 writes the latest HMI data of the nonvolatile memory 62 in the backup data holding part 514 at the time of startup of the real-time OS 51. Upon receiving a transmission request from the communication I/F 414, the data managing part 511 transmits the HMI data of the backup data holding part 514 to the communication I/F 414 via the communication I/F 515.

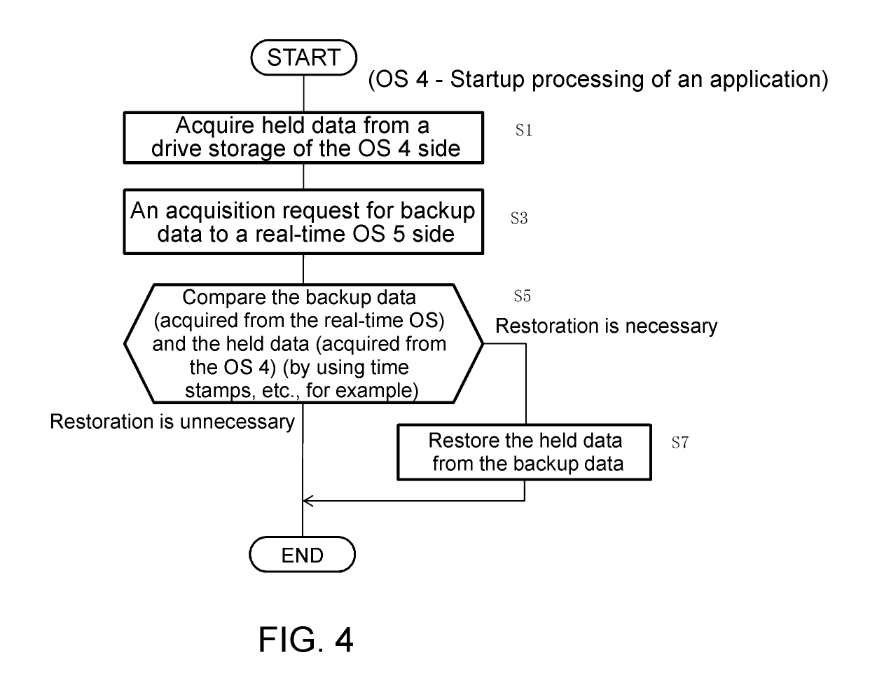

FIG. 4 is a flowchart showing startup processing executed by the data managing part 411 operating on the OS. Upon the startup of the HMI application 412, the held data stored in the drive storage 61 of the OS part 4 is read and acquired (Step S1). Next, the acquisition request for the backup data stored in the backup data holding part 514 is transmitted to the real time OS part 5 (Step S3). The data managing part 411 determines whether to restore the backup data to the held data buffer 413 from the time stamps of the backup data that is transmitted and acquired from the side of the real time OS part 5 in response to the acquisition request and the held data that is stored in the drive storage 61 (Step S5). That is, in the case where the held data stored in the drive storage 61 is temporally more recent than the backup data acquired from the side of the real time OS part 5, it is not necessary to perform the restoring processing of the held data. In this case, the mode in which the drive storage 61 is written may be adopted.

On the other hand, in the case where the backup data acquired from the side of the real-time OS part 5 is temporally more recent than the held data stored in the drive storage 61, the restoration for the held data is necessary; in other words, the backup data acquired from the side of the real-time OS part 5 is restored to the held data buffer 413 (Step S7). As a result, the most recent backup data is restored to the held data buffer 413 in response to the startup of the HMI application.

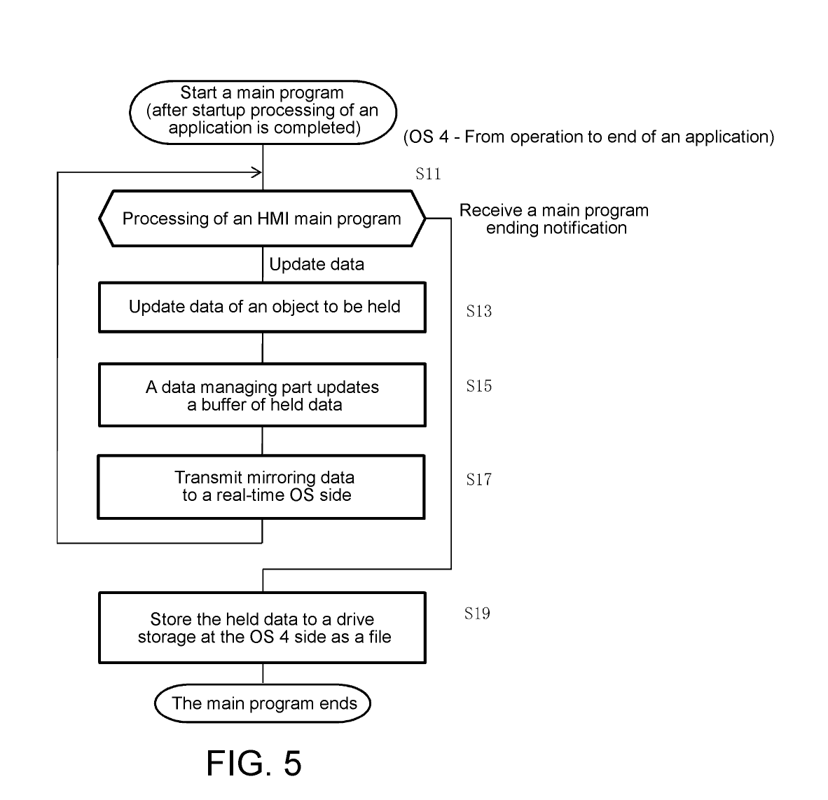

FIG. 5 is a flowchart showing processing from operation to end executed by the data managing part 411 operating on the OS. The HMI application 412 after startup determines, during operation, whether processing of an HMI main program is a data update of newly input HMI data or reception of a main program ending notification (Step S11).

In the case where the processing of the HMI main program is determined to be the data update of the newly input HMI data, the HMI data is set as data of an object to be held, and update processing is instructed. (Step S13). That is, the data managing part 411 updates and memorizes the held data of the object to be held in the held data buffer 413 (Step S15). Next, the data managing part 411 transmits the held data of the object to be held as the mirroring data to the side of the real-time OS part 5 (Step S17).

On the other hand, in Step S11, in the case where the processing of the HMI main program is determined to be the reception of the main program ending notification, the held data held in the held data buffer 413 is stored as a file in the drive storage 61 (Step S19). At this time, storing processing may be performed in association with the time stamp.

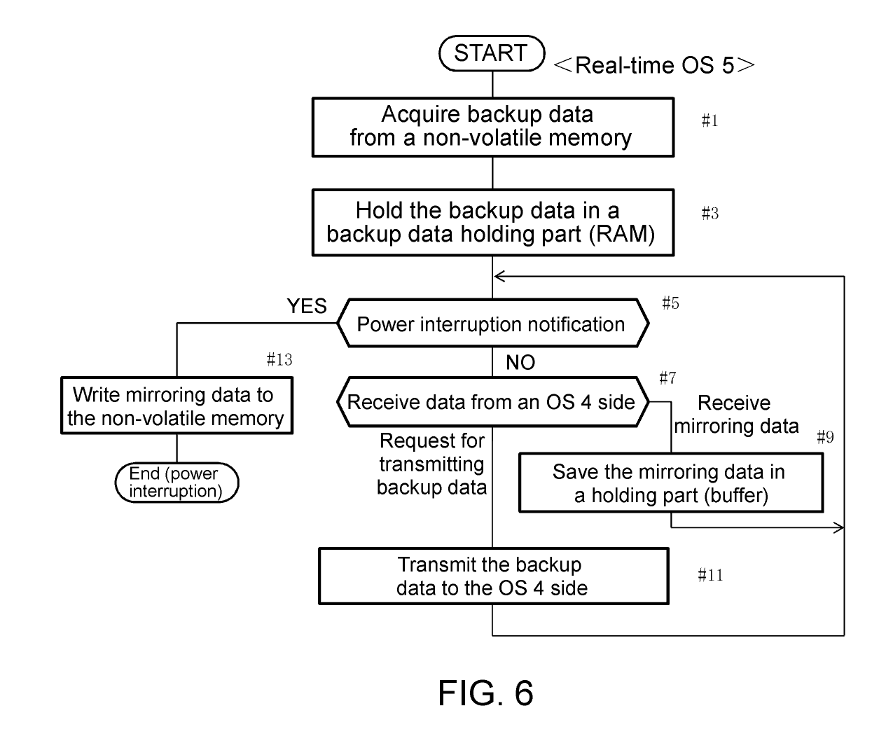

FIG. 6 is a flowchart showing power interruption processing, etc., executed by the data managing part 511 operating on the real-time OS. First, at the time of startup, the backup data is acquired from the nonvolatile memory 62 (Step #1). The acquired backup data is held in the backup data holding part 514 (Step #3). Through this processing, the backup data acquisition request from the OS part 4 can be responded immediately after startup.

Next, whether there is a power interruption notification is determined (Step #5). In the case where there is no power interruption notification, subsequently, whether data is received from the side of the OS part 4 is determined (Step #7). In the case where the data received from the side of the OS part 4 is the mirroring data, the data managing part 511 stores the received mirroring data in the mirroring data holding part 513 (Step #9) and the flow returns to Step #5. On the other hand, in the case where the data received from the side of the OS part 4 is the backup data acquisition request, the data managing part 511 transmits the backup data to the side of the OS part 4 (Step #11) and the flow returns to the Step #5.

Alternatively, in the case where there is a power interruption notification in Step #5, the data managing part 511 writes the mirroring data stored in the mirroring data holding part 513 to the nonvolatile memory 62 (Step #13). As a result, upon the startup after the power interruption, the mirroring data with the time stamp at the time of the power interruption is read from the nonvolatile memory 62 and stored in the backup data holding part 514 (Steps # 1 and # 3).

Considering the case where the power interruption occurs during writing of the mirroring data to the mirroring data holding part 513, for example, two mirroring data holding parts 513 may be provided alternately or redundantly (double writing) so as to ensure the integrity of the mirroring data.

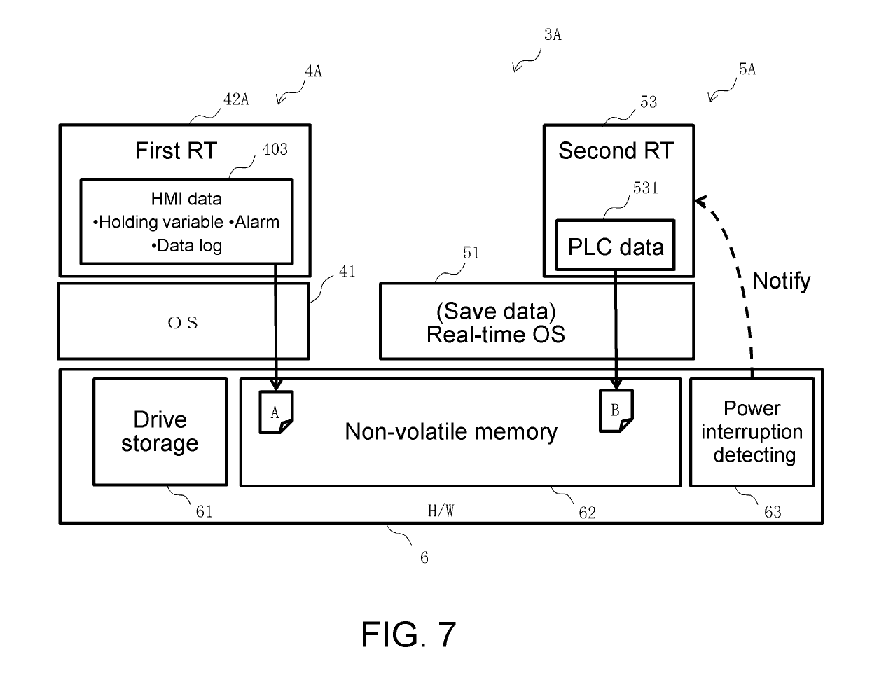

FIG. 7 is another block diagram of the controller. An IPC 3A shown in FIG. 7 is different from the IPC 3 of FIG. 2 in that the IPC 3A does not include the mirroring processing part 52 and that the mirroring processing is directly written from the second RT application 53 into the nonvolatile memory 62. The IPC 3A buffers the HMI data sequentially input along the time axis by a first RT 42A operating on the OS 41 and directly writes the HMI data to the nonvolatile memory 62 as the mirroring data via the OS 41. The buffered HMI data is stored in the drive storage 61 at a predetermined timing, such as the time point at which the first RT 42A ends. In this way, the life of the drive storage 61 is prolonged, the data loss is reduced as compared to the case of writing at a high frequency for each input of the HMI data, and the load at the side of a real-time OS part 5A side is alleviated.

In this embodiment, although the held data buffer 413 and the mirroring data holding part (buffer) 513 are described for storing the HMI data and the mirroring data, the held data buffer 413 and the mirroring data holding part (buffer) 513 are not limited to volatile memories, but may be nonvolatile memories. In this embodiment, the CPU 60 is described as a single processor, but a mode in which a multiprocessor controls the respective OSs may also be adopted.

The disclosure is not limited to the above embodiments, and at the implementation stage, the constituent elements can be modified and embodied within the scope not departing from the gist of the disclosure. Further, various inventions can be formed by appropriately combining a plurality of constituent elements disclosed in the above embodiments. For example, some components may be deleted from all the components shown in the embodiments. Further, the constituent elements across different embodiments may also be appropriately combined.

What is claimed is:

1. A controller, comprising a control part operating on a first operating system and a second operating system for controlling a control object, the controller comprising:
a first data managing part that performs acquisition processing of periodically input first data by an application program operating on the first operating system;
a first memory in which the first data is memorized by the first data managing part;
a second data managing part that exchanges data with the first data managing part by an application program operating on the second operating system; and
a second memory in which data is memorized by the second data managing part, wherein the first data managing part transmits the acquired first data to the second data managing part as mirroring data, and
wherein the second data managing part memorizes the mirroring data in the second memory.

2. The controller according to claim 1, comprising:
a first nonvolatile memory in which contents of the first memory are stored by the first data managing part at a time when the application program of the first operating system ends.

3. The controller according to claim 1, comprising:
a power interruption detecting part that detects power interruption of the control part; and
a second nonvolatile memory in which contents of the second memory are stored by the second data managing part upon detection of the power interruption.

4. The controller according to claim 2, comprising:
a power interruption detecting part that detects power interruption of the control part; and
a second nonvolatile memory in which contents of the second memory are stored by the second data managing part upon detection of the power interruption.

5. The controller according to claim 2, comprising:
a power interruption detecting part that detects power interruption of the control part; and
a second nonvolatile memory in which contents of the second memory are stored by the second data managing part upon detection of the power interruption,
wherein the second data managing part transmits contents of the second nonvolatile memory to the first data managing part in response to a request from the first data managing part, and
the first data managing part, at a time of startup of the control part, reads the contents of the first nonvolatile memory, compares the contents of the first nonvolatile memory with the contents of the second nonvolatile memory that are received, and restores latest contents to the first memory.

6. The controller according to claim 5, comprising:
a backup memory in which data is memorized by the second data managing part,
wherein the second data managing part, at a time of startup of the second operating system, reads the contents of the second nonvolatile memory to the backup memory, and transmits contents of the backup memory to the first data managing part in response to a request from the first data managing part.

7. The controller according to claim 1, wherein the second operating system is a real-time operating system.

8. The controller according to claim 2, wherein the second operating system is a real-time operating system.

9. The controller according to claim 3, wherein the second operating system is a real-time operating system.

10. The controller according to claim 5, wherein the second operating system is a real-time operating system.

11. The controller according to claim 6, wherein the second operating system is a real-time operating system.

12. A data storage method, in which a control part operating on a first operating system and a second operating system for controlling a control object performs following:
an acquisition step of acquiring periodically input first data by an application program operating on the first operating system;
a first memory step of memorizing the first data acquired in the acquisition step in a first memory;
a transmission step of transmitting the first data acquired in the acquisition step to the side of the second operating system as mirroring data; and
a second memory step of memorizing the mirroring data in a second memory by an application program operating on the second operating system.
